(19) United States
(12) Patent Application Publication
(10) Pub. No.: US 2004/0117820 A1
(43) Pub. Date: Jun. 17, 2004

(54) Streaming portal and system and method for using thereof

(76) Inventors: Michael Thiemann, Krefeld (DE); Dirk Hannemann, Krefeld (DE)

Correspondence Address: Aslan Baghdadi, Shaw Pittman LLP, 1650 Tysons Boulevard, McLean, VA, 22102, US

(21) Appl. No.: 10/661,565

(22) Filed: Sep. 15, 2003

(30) Foreign Application Priority Data
Sep. 16, 2002 (DE) 10243096.9-53

(51) Int. Cl. G06F 13/00

(52) U.S. Cl. 725/37

(57) ABSTRACT

A streaming portal is provided with at least one display frame for playback of multimedia information of a program offered by an information provider whereby the multimedia information is made available for the streaming portal as multimedia data and the multimedia data is available for playback as a group of data streams. The multimedia data is divided into a group of streaming units in accordance with the configuration data determined from the program whereby the streaming unit is marked with an identifier that identifies the type of multimedia data contained in the streaming unit and the streaming unit is played back as a data stream in a display frame that identifies the information provider and preferably also the type. The multimedia data are played back on the streaming portal in a display frame that has been designed to play back all the data and that identifies the information provider.

This application claims priority under 35 USC § 119 (a)-(d) to German Application 10243096.9-53 filed Sep. 16, 2002, the disclosure of which is hereby incorporated by reference for any purpose.

### BACKGROUND

1. Field of the Invention

The invention relates to a streaming portal fitted with at least one display frame for playback of multimedia information from a program offered by an information provider whereby the multimedia information is made available as multimedia data and the multimedia data are played back as a group of data streams. Furthermore, the invention comprises a computer device with the streaming portal as well as a process for providing the streaming portal with a least one display frame for playback of multimedia information from a program offered by an information provider, whereby the multimedia information is made available for the streaming portal as multimedia data and the multimedia data are played back as a group of data streams.

The invention relates to a computer program product, as well as a computer readable media for storage of the computer program product.

The invention also relates to a computer network for providing a streaming portal with at least one display frame for playback of multimedia information from the program offered by an information provider and comprising: a receiver via which the multimedia information is made available and a converter that makes the multimedia information available as multimedia data whereby the multimedia data are played back as a group of data streams.

Furthermore, the invention comprises a first, second and third computer program that provides the streaming portal with a least one display frame for playback of multimedia information from a program offered by an information provider, whereby the multimedia information is made available for the streaming portal as multimedia data and the multimedia data are played back as a group of data streams. The invention also comprises the use of a first, second and third computer system.

2. Background of the Invention

It would be advantageous for an Internet information provider to be able to present the data he has available in a well-organized fashion and it should be displayed using a corporate design. This applies in particular to information providers in the broadcasting, radio, television or other similar news provider sectors. In other words, an information provider who actually provides the information by means other than via the Internet but also wishes to use the Internet. A good example of just such a service is the Internet pages provided by WDR-Rundfunk. Such types of web pages could still be improved. A corporate design is only partly being used.

Navigation indicators for multimedia information, in particular audio-video information, could be displayed in a better-organized fashion on a streaming portal. When the information must be provided and updated, often considerable manual effort is required to produce a well-organized display using the corporate design. This is not advantageous for, in particular, audio-visual media playback. Such manual effort can be limited through the use of appropriate technical measures.

Regular web pages, such as, for example, Apple's web page do not use a corporate design when a user clicks on a reference to a video stream or other audiovisual or multimedia data. Usually, random and therefore completely unorganized separate links for video stream playback are used. It then appears in a window used for the playback functions that then plays back the video stream, however, without the corporate design, which is a disadvantage for the information provider.

In practice, this means that to date when a user requests audiovisual media on any usual web page on the Internet, a neutral window from a playback tool such as, for example, RealPlayer, appears with no reference to the information provider. Usually, no recognition factors exist for specific themes offered by the provider such as, for example, a broadcast series by a broadcasting station or a television station.

In particular, private or public information providers in the area of broadcasting or television have problems automatically converting their own programs, in other words, in particular, moving images or sounds to a stream in an effective and organized fashion with recognition value and a uniformly designed portal accompanying programs.

### BRIEF SUMMARY OF THE INVENTION

It is in this connection the invention can offer a solution since it is an object of the present invention to provide a streaming portal, a device with a streaming portal, a process and a device for supplying the streaming portal, a computer program product as well as use of a computer device for supplying, in particular, the provision of, conversion of and/or interactive use of a streaming portal, whereby, the delivery should be effective and whereby the streaming portal is provided with recognition value for the information provider.

With regard to the streaming portal, an object of the present invention is achieved by means of a streaming portal of the above-mentioned type that in accordance with the invention provides that the multimedia data are divided into a group of streaming units on the basis of the configuration data determined from the program, whereby a streaming unit is supplied with a label that identifies the type of multimedia data contained in the streaming unit and the streaming unit is supplied with a display frame that identifies the information provider and is played back as a data stream.

As defined by the present application, a streaming portal means a playback platform and a data pool for information that can be played back, in particular, on a network of any kind (such as on the Internet, Intranet, WAN, LAN) and that plays back and/or fetches information in any form (text, image, audio, video) by means of single and/or a functional unity of a group of linked portal pages (playback windows, display frames), whereby the entire computer program (such as automatically or also manually generated) is stored and one or several playback functions are implemented. As defined by the present application, the streaming portal is not simply a data bank and/or its screen display but it also includes, as a functional unity, the technical linkage of stored computer programs and playback tools. The functionality of the streaming portal can also be realized by means of one single portal page, meaning that, as defined by the present application, a streaming portal also means a single portal page. In addition to the above-mentioned networks, mobile and/or radio networks, and, in particular, broadband networks such as UMTS are also used for the implementation of the suggested concept for providing the streaming portals.

By information is meant, in particular, multimedia information, such as, for example, moving animations and/or audio or video information, in particular, if they were or are already the object of a transmission outside a network so they initially could be available in analog form but also could be available in digital form. Multimedia information contains all types of dynamically generated sequences, in particular, image sequences and/or sound sequences. These could, as is the case with animation, be generated live or be prepared in advance.

Additionally, other information could be available as additional data, such as text, graphics or an image as well as links in a display frame. Such common data are displayed in a display window or frame, in other words on a page or in a window on the streaming portal. A series of playback tools are particularly suitable for playing back multimedia information such as, for example, RealPlayer. In other words, a playback tool is a means of downloading, playing back and displaying an audio-video stream, possibly influenced by the playback operation. A stream basically means all data that must be played back after a required stipulated period of time and thus, for example, will play back moving images or sound. The display of video streams usually occurs in a playback window or display frame. As defined by the present application, a display frame not only means the actual window (window), but rather, in particular, the entire layout including additional applications that are provided within the frame or on the frame, in particular, for use for the corporate design.

The essential idea behind the present invention is the establishment of a streaming portal that has a universal navigation concept for all users and that therefore is well organized and is fitted with a recognition value for the information provider. Explained in simpler terms, the concept puts into practice, in particular, a network-broadcaster, in other words, a “television broadcaster” on a suitable network while providing universal navigation for the user and a recognition value for the information provider. This could, for example, be a web broadcaster on the Internet. The discovery of the invention is that a suitable hardware and software environment as well as, in particular, appropriate preparation and processing of the data material can facilitate the establishment of the streaming portal and this, in a very effective and mostly automatic fashion. The corresponding devices, processes and uses in accordance with the invention will be described below. Firstly, the invention comprises the above mentioned automatic configuration determination of the multimedia data and a corresponding classification of the data and the automatic marking and the corresponding identification of the data in order to play back the data as a data stream in a display frame that identifies the information provider. In this connection, it is particularly advantageous if the streaming unit when played back as a data stream is also fitted with a display frame that identifies the type of multimedia data.

The invention comprises a computer device with the already described streaming portal used for playback of multimedia information of a program offered by an information provider on the streaming portal. Additionally, the invention comprises a process for providing the streaming portal and a corresponding computer program product as well as a computer device for providing the streaming portal. This is described in further detail below.

Firstly, in accordance with the dependant claims for the streaming portal, additional preferred embodiments of the invention with regards to the streaming portal will be described. Advantageous possibilities when implementing the streaming portal will be described in detail.

Preferably, all data on the streaming portal, particularly the multimedia data are played back on a display frame that has been designed to play back all the data and that identifies the information provider. A corresponding display frame can be provided for every streaming unit. This ensures the user recognition value.

The program is, in particular, a television and/or broadcasting program offered by an information provider. Most importantly, a group of pre-selected criteria for the determination of the configuration data of the program can be self-determined. This applies in particular to one or several of the following criteria. A criterion could, for example, be the time, in other words, in particular, the time of broadcasting or the duration of the broadcast. In other words, the configuration of the program could be determined on the basis of the broadcasting time. Every streaming unit would be formed by a broadcast. The group of streaming units would be configured in accordance with the broadcasting time and duration of the broadcast.

Furthermore, the configuration could occur on the basis of themes. In this manner, multimedia data could be configured, for example, in terms of the news, movies, and series or from other thematic standpoints.

In an analogous manner, the configuration could occur on the basis of a particularly well-known performer or a producer or a director.

Configurations that consider local criteria are also possible. For example, broadcasts that are relevant to a certain region, for example, a state or a district, could be united as one configuration topic.

Equally, highly topical broadcasts could be united under one specific configuration topic.

Broadcasts that are not in German but rather in, for example, French, Dutch or English could, for example, be configured together and offered to the German border regions.

Any such grouping could advantageously be fitted with a characteristic identifier. In other words, the streaming unit is provided with a display frame that identifies the type of multimedia information contained in the streaming unit. Here, the technical possibilities can be applied to, above all else, the design of the display frame itself. However, a particular icon designating a certain type of multimedia data could also be provided. In this manner, a specifically designed icon could serve as an identifier for a display frame for, for example, morning, afternoon or evening broadcasts. Icons that designate a certain region could also be chosen or local criteria could be used with regard to the data. Other possibilities are apparent when an icon that functions as an identifier for a broadcast is included or superimposed in the design of the display frame. The streaming unit of the corresponding broadcast is thus played back in a display frame that is characteristic for the broadcast.

Additional possibilities of identification are provided to identify the stream type as such. Equally, the design of the display frame can be adjusted to suit the stream type—depending on whether the stream type is an audio, video, live, television, interactive stream or a common streaming unit such as animation or something similar. The stream type describes at least the nature of the dynamic sequence. By stream type is also meant the type of content as has been described above.

It has proven to be particularly advantageous if such identifiers are already posted on the home page of the streaming portal. It would be particularly advantageous if the home page provided a menu that offered access to streaming channels, television choices, live stream choices, audio choices, interactive services or the latest news.

Each of the additional embodiments described above are described in further detail in FIGS. 2 to 4 which show the preferred embodiment of an Internet portal.

Furthermore, it would be advantageous if each broadcast of the program were assigned a group of display frames on the streaming portal.

In particular, the streaming portal can be connected to additional and common networks, in particular, to Internet services. For example, common Internet pages could be provided with a link to the streaming portal.

In a particularly advantageous embodiment of the proposed streaming portal the display frame assigned to each broadcast of the program contains an additional link that provides access to the multimedia data that correspond to the broadcast and which extend beyond the content of the broadcast. In this manner, in a particularly advantageous fashion the information provider can post additional information about a broadcast of the program for use on the Internet that is not available in other broadcasts of the program offered by the information provider. Here supplementary press releases or interviews or opinion polls about a broadcast could be posted as streaming units. It is also possible to provide a script for a film, chapter subdivisions and other links. For example, a particular “chapter” of a film could be directly accessed by way of such a link.

It has proven particularly advantageous if a number of display frames are grouped and assigned to a group of broadcasts. Instead of a broadcast the group could also be assigned to a particular theme or to another program content with the same characteristics. Preferably, the grouping would have a design that corresponds to the broadcast. On the one hand, in this manner a particularly well-organized and efficiently designed streaming portal is realized. On the other hand, the possibility now exists to increase the recognition value by identifying the type of multimedia data contained in the streaming unit and the information provider.

A display frame also can be designed to be multilingual.

The above-mentioned linkage and execution of the characteristic display frame is the result of the stored configuration and marking of the multimedia data. In accordance with the invention, this occurs by means of a process of the type mentioned above, in which, in accordance with the invention

a configuration of the multimedia information is determined from the program and is made available as configuration data,

the multimedia data are divided into a group of streaming units on the basis of the configuration data,

a streaming unit is provided with a marking that identifies the type of multimedia data contained in the streaming unit, and

for playback as a data stream, the streaming unit is provided with a display frame that identifies the information provider.

Preferably, the streaming unit is also provided with a display frame that identifies the type of multimedia data contained in the streaming unit. The configuration of the multimedia information is favorably specified according to demand on the basis of specific criteria. The configuration data are then advantageously made available as an automatically generated data file that, however, is manually influenceable. All additional process steps could then progress mostly automatically or fully automatically in a suitable device in a controlled manner.

Preferred embodiments of the invention with regards to the process are described in the dependant claims for the process and they describe in detail advantageous possibilities that, on the one hand, provide access to the multimedia information of an information provider and on the other hand divides the multimedia data on the basis of the configuration data into a group of streaming units. This can occur in a technically particularly preferred manner. An example of a particularly preferred embodiment of the process is shown in FIGS. 5 to 7.

In particular, the multimedia data are played back on the streaming portal in a display frame that has been designed to play back all the data and that identifies the information provider. During the playback for the user of the portal there is a recognition factor since the corporate design of the provider always is present on the portal.

The multimedia information for the streaming portal could, for example, be supplied to a computer network by way of a receiver, then be converted to analog/digital or digital/digital multimedia data and be made available in this form for the streaming portal. The multimedia data would then advantageously be played back as a group of data streams. Configuration of the multimedia information is determined by means of the program. This, for example, could be one of the configurations mentioned above in connection with the streaming portal (such as, for example, time, theme, performer, producer, director, local criteria, language and topicality). The streaming units would be correspondingly classified and every streaming unit would be provided with a marker or a label. This could be a code or a number. In this manner any desired part or the entire program of an information provider could automatically be digitized, configured and in a meaningful way be classified according to predetermined criteria in the program and then stored as streaming units, preferably as a databank of streaming units in a marked form. This configuration and marked storage process of the program offered by an information provider could progress automatically under the control of software on a hardware unit. The data pool generated in this manner, in other words, configured and with each stream unit identified by the means of markers, forms the basis for the provision of the streaming portal described above.

In accordance with the marking of a streaming unit of preferably every group of streaming units the streaming unit is played back as a data stream in a display frame that identifies the type of multimedia data contained in the streaming unit. When calling the appropriate streaming unit, the layout and the display method, in other words, the display frame as well as additional icons or identifiers that corresponds to the markings, would already be stored and could automatically be accessed. Every streaming unit is then automatically assigned a display method that, preferably, is characteristic of the type of multimedia data contained in the streaming unit, but in any event, is assigned a display frame that is designed to identify the information provider.

All data other than multimedia data on the streaming portal are preferably played back in a display frame that has been designed to play back all the data and that identifies the information provider. This is, for example, the case for a display frame with color or acoustic features.

Firstly, the process permits that on the one hand any desired part of the program or the entire program offered by an information provider is automatically configured and is marked according to the type of multimedia information it is. The configuration data provided for this purpose could be made available to a large extent by means of show-view and/or Meta data. This facilitates the availability of a wide palette of configuration possibilities when preparing the program and when it is later used by a user (hereafter called user). Furthermore, to allow playback of a streaming unit in accordance with the stipulations given by the information provider, the layout can be automatically realized and be adjusted editorially by way of, for example, control software for playback of a streaming unit.

In a preferred embodiment, the multimedia information for the streaming portal is made available by means of a receiver. This could, for example, be an antenna, in particular, a satellite receiver or a cable receiver. The conversion to digitized information material in the form of multimedia data best occurs via an analog-to-digital converter. Alternatively or additionally, multimedia data or additional data from the information provider could also be made available via a data storage unit and/or a network, for example the Internet. In other words, the multimedia data or data could be filed on a data storage disc or otherwise on a server or a computer. It is also possible that the data and/or multimedia data from the information provider be electronically transmitted by data transmission in a network, for example, the Internet, by e-mail. Independent of the type of data transmission the information material can also be available as digital material. The converter could also be a digital-to-digital conversion unit.

In a particularly advantageous embodiment, the program offered by the information provider is made available together with the multimedia information. In this manner, the criteria for the configuration of the program are advantageously delivered with the program itself.

It is furthermore advantageous that the classification of the streaming unit in the configuration occurs according to a header of the streaming unit. In other words, the marking advantageously occurs in the header of the streaming unit. In this manner, the header would be read first when calling a streaming unit. By means of the marking, the header would immediately identify the type of multimedia information contained in the streaming unit. In this manner, when calling the streaming unit, for data technical reasons the display frame for playback of the streaming unit with all the applications that accompany it including recognition factors such as an icon or an acoustic background are also immediately called. The program could also be made available separately from the multimedia information, for example, via a network or radio communication link, for example, as a show-view data file. Such information usually already lies ready on a network in a suitable form, for example, on the Internet, and could be directly used in this manner.

The streaming portal can naturally also be built up in such a way that it plays back the program of a group of information providers. This is advantageous when many program providers work together on either certain parts of their program or on their entire program.

The invention comprises a computer program product which can be stored on a computer readable media and is fitted with a software code segment that is suitable to initiate a computer device for playback of multimedia information of a program offered by an information provider on a streaming portal as described above when this computer program product is implemented on a computer device.

The invention also comprises a computer program product which can be stored on a computer readable media and is fitted with a software code segment that is suitable to initiate a computer device to perform the process as described above when this computer program product is implemented on a computer device.

The invention also comprises a computer readable media, on which a computer program product as described above is stored.

With regard to the device, the object of the invention is achieved by means of a computer network for the provision of a streaming portal of the type mentioned above that in accordance with the invention comprises:

at least one computer system,

in which the multimedia information is made available in accordance with the configuration determined from the program

in which the multimedia data can be divided into a group of streaming units by means of the configuration data,

in which a streaming unit is provided with a marker that identifies the type of multimedia data that is contained in the streaming unit, and

in which the streaming unit is provided with a display frame that identifies the information provider.

Advantageous embodiments are described in the dependant claims for the computer network. Details about the computer network are described in an example of a preferred embodiment in connection with FIG. 8.

Preferably, the streaming unit is provided with a display frame that identifies the type of multimedia data that is contained in the streaming unit.

Advantageously, the computer network has a computer system that allows the data on the streaming portal to be played back on a display frame that has been designed to play back all the data and that identifies the information provider. This is, in particular, the case for a client (client) or user (user) computer system.

It is particularly advantageous if the group of streaming units is grouped into: streaming, audio, interactive, and live or television categories. In this manner, a favorable collection of categories is available. Naturally, other and additional categories could also be employed. The mentioned categories are particularly suitable for data transmission between computer units or computer systems in the network in separate data flows corresponding to the categories. Advantageously, a first channel is provided for live data, a second for television/audio data and a third channel is provided especially for web-television data. The computer units or computer systems of the computer network are advantageously connected to a network, for example, the Internet or a mobile network. It is particularly suitable for the computer network as well as for a LAN and also a WAN environment.

In particular, the computer network could advantageously be fitted with a broadcasting unit for handling live broadcasts. Particularly advantageous would be, for example, a studio from which live broadcasts could be transmitted. In this manner, an Internet add-on broadcast can be especially produced in connection with a conventionally produced broadcast from the information provider and, exclusively intended for the Internet, be played back on the streaming portal.

With regard to the device, the object underlying the invention is also achieved by means of a first computer system for providing a streaming portal with at least one display frame for playback of multimedia information from a program offered by an information provider, comprising

a receiver via which the multimedia information is made available,

a conversion unit via which the multimedia information becomes available as multimedia data whereby the multimedia data are played back as a group of data streams,

that in accordance with the invention

is designed as a capture system, and

in which a configuration of the multimedia information determined from the program is made available as configuration data,

in which the multimedia data can be divided into a group of streaming units on the basis of the configuration data,

in which a streaming unit has a marking that identifies the type of multimedia data contained in the streaming unit so that the streaming unit is provided with a display frame that identifies the information provider.

With regard to the use, the object underlying the invention is also achieved by means of the use of a first computer system for providing a streaming portal with at least one display frame for playback of multimedia information from a program offered by an information provider whereby

the multimedia information is made available for the streaming portal as multimedia data and

the multimedia data are made available for playback as a group of data streams,

that in accordance with the invention

is used as a capture system. In the capture system

a configuration of the multimedia data is determined from the program and is made available as configuration data,

the multimedia data are divided into a group of streaming units in accordance with the configuration data and

a streaming unit is marked with an identification of the type of multimedia data contained in the streaming unit so that the streaming, unit for playback as a data stream, is provided with a display frame that identifies the information provider.

A capture system is particularly suitable for this purpose, and, among other things, it comprises: capture software, video footage raid, in particular a RealVideo footage raid, a SMIL software creator and an administrator unit.

The capture system is especially designed to determine a configuration of the multimedia information and to make available a classified configured and correspondingly marked data collection of multimedia data as a group of classified streaming units. The capture software primarily serves to receive the multimedia information. The RealVideo footage raid and the SMIL software creator permit the preparation of raw data as multimedia data and the configuration of the data by means of suitable configuration information from the program. The administrator unit serves to control and supervise the otherwise automatic process and facilitates the linkage of the capture system with a second computer system.

With regard to the device, the object underlying the invention is also achieved by means of a second computer system for providing a streaming portal with at least one display frame for playback of multimedia information from a program offered by an information provider to which

the multimedia information is made available as multimedia data whereby

the multimedia data are played back as a group of data streams and

in accordance with the invention

the multimedia data are divided into a group of streaming units on the basis of the configuration data

determined from the program whereby

a streaming unit is provided with a marking identifying the type of multimedia data contained in the

streaming unit and

the second computer system is designed as a peripheral system in which the streaming unit is provided with a display frame that identifies the information provider.

With regard to the use, the object underlying the invention is also achieved by means of the use of a second computer system for providing a streaming portal with at least one display frame for playback of multimedia information from a program offered by an information provider to which

the multimedia information is made available for the streaming portal as multimedia data whereby

the multimedia data are available for playback as a group of data streams that in accordance with the invention

is used as a peripheral system. In so doing, the multimedia data are divided into a group of streaming units on the basis of the configuration data determined from the program whereby a streaming unit is provided with a marking that identifies the type of multimedia data contained in the streaming unit. In the peripheral system the streaming unit is provided with a display frame that identifies the type of multimedia data contained in the streaming unit and the information provider.

Thus, in the peripheral system the configured and correspondingly marked raw information in the form of multimedia data is further processed. This is primarily an editorial processing and a processing with regards to the presentation of the layout that identifies the information provider. This is best accomplished automatically and in accordance with a predetermined standard. The first computer system could, in principle, also perform this processing.

However, in accordance with a preferred embodiment, advantageously, the second computer system has a first server unit for displaying the streaming portal. It is arranged as or has a link computer unit that, in particular, is intended to process streaming requests. The peripheral system is preferably accommodated with the information provider who, apart from having an automatically running control operating software, also has additional possibilities of exerting influence. It is thus advantageous to have available to him a maintenance system as part of the peripheral system and input tool software.

According to a particularly preferred embodiment, to handle large data masses, a second server that is a dynamic RealVideo server used for the conversion of multimedia data for the first server unit is provided. This second server unit primarily performs tasks such as administration, storage and execution of the streaming units in the corporate design or also the footage data. Both the capture system and the peripheral system, which are also a first and second server unit within the peripheral system, are preferably connected to each other via suitably dimensioned data channels. There could, for example, also be separate data channels for television/audio, web television or live data.

The above-described embodiments of the second computer system have the advantage that a user can make a request to the link computer unit and be served by the dynamic RealVideo server.

With regard to the device, the object underlying the invention is also achieved by means of a third computer system for providing a streaming portal with at least one display frame for playback of multimedia information from a program offered by an information provider to which the multimedia information is made available as multimedia data whereby the multimedia data are available for playback as a group of data streams and in which in accordance with the invention

the multimedia data are divided into a group of streaming units on the basis of the configuration data determined from the program whereby a streaming unit is provided with a marking identifying the type of multimedia data contained in the streaming unit and whereby the streaming unit is provided with a display frame that identifies the information provider and

the third computer system is designed as a user system in which

the multimedia data on the streaming portal can be played back on a display frame that has been designed to play back all the data and that identifies the information provider.

With regard to the use, the object underlying the invention is also achieved also by means of the use of a third computer system for providing a streaming portal with at least one display frame for playback of multimedia information from a program offered by an information provider whereby

the multimedia information is made available for the streaming portal as multimedia data and

the multimedia data are available for playback as a group of data streams.

In accordance with the invention, the third computer system is used as a user system. In accordance with the configuration data determined from the program, the multimedia data are classified into a group of streaming units whereby a streaming unit is provided with a marking that identifies the type of multimedia data contained in the streaming unit and the streaming unit for playback as a data stream is provided with a display frame that also identifies the information provider. On the user system the multimedia data on the streaming portal is played back in a display frame that has been designed to play back all the data and that identifies the information provider.

The user system could also be a home recorder. The configuration data is accessible to the user system so that a client is able to put together the display options of his choice from a favorably chosen user prompt. In so doing, the client can not only choose broadcasting time and channel as a criteria. He may also choose from other configuration data such as thematic factors, broadcast category (movie, news and so forth), performer, topicality, local criteria and similar data to put together the display options of his choice.

According to a further embodiment, in particular, the use of a multimedia personal computer with on-screen user prompt is provided for. It could either be a mobile station such as, for example, a mobile phone. Furthermore, it could be a home computer. It could also be a stationary, permanent base station in a public place or an Internet Café that is especially intended for displaying the streaming portal offered by the information provider.

While the invention is particularly suitable for use by information providers in the area of broadcasting and television and while a program offered by an information provider, in particular, means information for a broadcasting and/or television program or a broadcasting and/or television operating center, and even though the invention will be described in further detail below using examples from the broadcasting and television areas, it should be made clear that the concept described here, which includes a streaming portal, a computer device, the process for supplying the streaming portal, the computer program product as well as the computer network and the first, second and third computer system and use thereof would, as claimed, be equally useful for other uses that do not fall within the framework of and concern information providers that do not work with broadcasting and television or similar broadcasting operations. Commercial information providers, who mainly distribute multimedia information, could, for example, use the disclosed concept. It would be particularly suitable for uses that require reaching a mass audience and/or concern an event. An example of such a user would be a business that runs cinemas or a film production company. With improving computer performance and network technology practically any company as well as every private citizen is able offer advertisement or a self-portrayal on a network using the disclosed concept. It would also be advantageous if the concept were to be used by, for example, the tourism industry, travel bureaus, concert promoters, the entertainment industry or if it were used for the on-board television on the train, on an airplane and in the car. Here too, the disclosed concept offers the already disclosed advantages to the information provider. The information provider will be able to present his multimedia information in a particularly effective manner that allows them to provide recognition value on any desired network that has the required bandwidth. In this connection, program would mean the multimedia information the information provider lists as being available. A cinema operator would, for example, list the current movie program. A film production company would, for example, list the current film production program. Other companies might list the advertisement program that the company describes and/or have submitted tenders for.

Examples of implementation of the invention will be described below by way of the drawings in comparison with prior art which is also partly described. This should not decisively portray the implementations since the drawings are schematic and/or slightly distorted when necessary to improve understanding. With regard to supplementing the template directly discernible from the drawing, one is referred to the relevant prior art.

In this regard, it should be taken into consideration that many modifications and changes could be made with regard to the design and details of an implementation without deviating from the general idea of the invention. The invention specifications described above, in the drawings as well as in the claims, could be significant both individually and in any chosen combination for the different implementations of the invention. The basic idea of the invention is not limited to the exact design nor the details of the implementation described below nor limited to one item that would be restrictive in comparison to the item claimed in the patent claims.

A section of the specifications for this patent application contain materials that are the object of copyright protection. This patent application shows and/or describes items that are or could become works of the owner. The owners of the copyright protection and the works do not oppose the facsimile copying of the patent specifications as they appear in the files or records of the Patent and Trademark Office, but reserve all their trademark and copyright protection rights.

### BRIEF DESCRIPTION OF THE DRAWINGS

FIG. 1 is an example of a home page of a streaming portal for playback of multimedia information of a program from a broadcasting and television provider in accordance with prior art;

FIG. 2 is an example of a home page in a particularly preferred embodiment of a streaming portal of a broadcasting and television provider with a display frame that identifies the information provider in accordance with the proposed concept;

FIG. 3 is an example of an identifier for a preferred display frame in the form of icons for identification of the streaming type for the preferred embodiment;

FIG. 4 shows other examples of identifiers for a preferred display frame in the form of logos that identify the multimedia data type contained in a streaming unit whereby a specific broadcasting sequence is referred to;

FIG. 5 is a very simplified diagram clarifying the technical sequence of operations with regards to: the classification of streaming units in accordance with one of the programs available and the marking of a streaming unit with a designation identifying the type of multimedia data contained in the streaming unit for playback as a data stream in a display frame that identifies the type and the information provider on a streaming portal in accordance with the preferred embodiment;

FIG. 6 is a very simplified display of the operating sequence during an automatic classification and marking as well as placement of an identifying display frame for multimedia data on a streaming portal according to the preferred embodiment;

FIG. 7 is a “live & on-demand” stream data file as the result of the operating sequence according to the preferred embodiment;

FIG. 8 is a particularly preferred embodiment of a computer network that provides for the use of a first computer system as the capture system, a second computer system as the peripheral system with an additional dynamic RealVideo server and a third computer system as the user system;

FIG. 9 is another example of a home page of a particularly preferred streaming portal within the framework of a navigation example (FIGS. 9 to 12), whereby all data are played back on the particularly preferred embodiment of the streaming portal in a display frame that has been designed to play back all the data and that identifies the information provider;

FIG. 10 is a menu designed for a particular region of the particularly preferred embodiment of the streaming portal within the framework of the navigation example (FIGS. 9 to 12);

FIG. 11 is another menu for playback of multimedia information that is regional and time specific for the particularly preferred embodiment of the streaming portal within the framework of the navigation example (FIGS. 9 to 12);

FIG. 12 is a particularly preferred embodiment of the playback of a streaming unit as a data stream in a display frame that identifies the type of multimedia data contained in the streaming unit and the information provider within the framework of the navigation example (FIGS. 9 to 12);

FIG. 13 is another example of playback of a streaming unit as a data stream in a display frame that identifies the type and the information provider according to the particularly preferred embodiment;

FIG. 14 is an example of a link in the particularly preferred embodiment of the streaming portal to the conventional Internet;

FIG. 15 is an example of a display frame assigned for the broadcast of a program with links that make accessible the multimedia data that concern the broadcast and that extend beyond the content of the broadcast according to the particularly preferred embodiment of a streaming portal;

FIG. 16 shows other examples of display frames as seen in FIG. 15;

FIG. 17 is an example of a group of display frames that are grouped and assigned to a broadcast for the particularly preferred embodiment of a streaming portal whereby the group has designs that correspond to the broadcast; and

FIG. 18 is an example of a multilingual display frame for the particularly preferred embodiment.

### DETAILED DESCRIPTION OF THE INVENTION

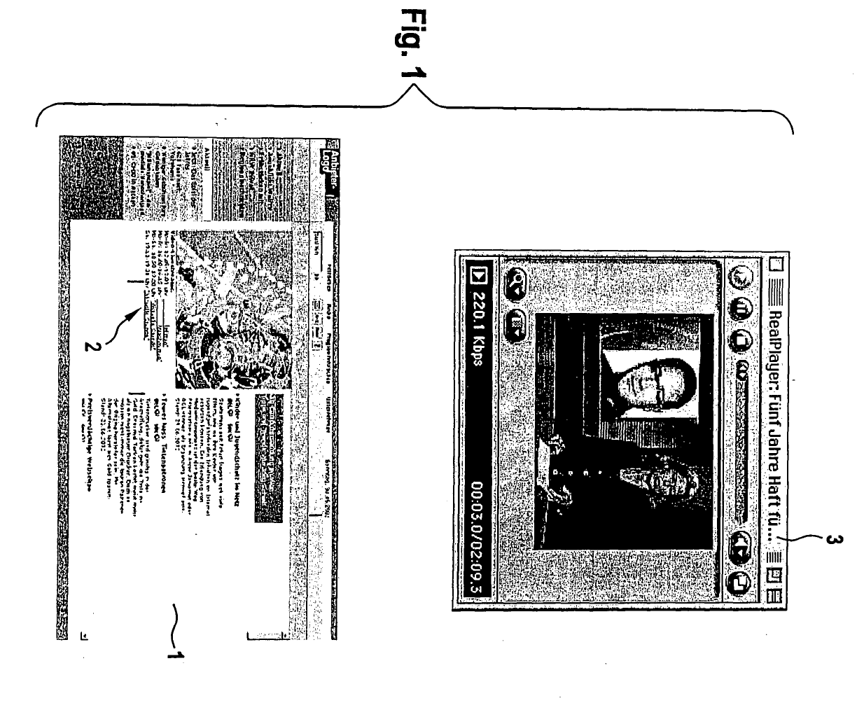

FIG. 1 shows a well-known web page 1 in accordance with prior art that facilitates playback of multimedia information from a program offered by a television and broadcasting service. Appropriate links 2 are provided on the web page 1 that facilitate fetching of the audiovisual media, when the links 2 are clicked on with a mouse.

However, this page is still missing comprehensive user guidance. The links to multimedia streams are spread out over the page. There is no overview of the “streaming” offered by the information provider, the choice of “teasers” or “eye catchers”. Furthermore, when fetching a streaming unit for playback of multimedia data as a data stream, the display shows no corporate design. In other words, when fetching audiovisual media in accordance with the prior art shown here, it is simply a RealPlayer window 3 that appears without any reference to the information provider. No recognition factors exist with regard to a broadcasting sequence or a program item on the television or sound broadcasting offered by the information provider when the data stream is played back in the RealPlayer window.

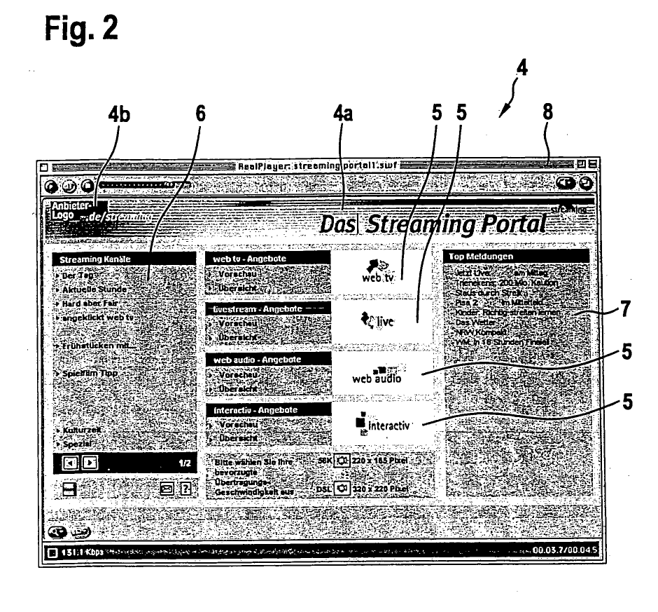

In FIG. 2 an example of a home page of a particularly preferred embodiment of a suggested streaming portal 4 as shown. All data on streaming portal 4 are played back in a display frame that has been designed to play back all the data and that identifies the information provider. The colors used on display frame 4a and/or for logos 4b offered by the information provider are consistently used for the streaming portal. This is particularly the case for the multimedia data. This enables the use of a complete streaming solution so that the multimedia information from the broadcasting and television providers can be displayed in the corporate design. This is, in particular, the case for the streaming units that are always displayed as data streams in the corporate design. The Internet streaming portal is conceived in such a way that the production and preparation of both the raw data, or in other words, the multimedia data that were derived directly from the multimedia information, and the characteristic identification of the data with corporate design modular units, or in other words, icons, logos and display frames can occur basically automatically and quickly and a corresponding tool for the maintenance of audiovisual content can be efficiently assigned.

The streaming portal comprises a grouping 5 of the streaming content into web television, live stream, web audio and interactive choices. These “choices” are labeled with a corresponding icon 5 that characterizes the stream type. Furthermore, the page has a menu item called “streaming channels” that enables access to an interactively user-defined television program 6 from the Internet and facilitates viewing it on a console at the user's disposal. Furthermore, home page 4 offers a possibility to view news messages 7 either as common data presentation or as multimedia data in the form of a data stream in a display frame that identifies the type of multimedia data contained in the streaming unit and the information provider. Home page 4 is displayed with a playback tool

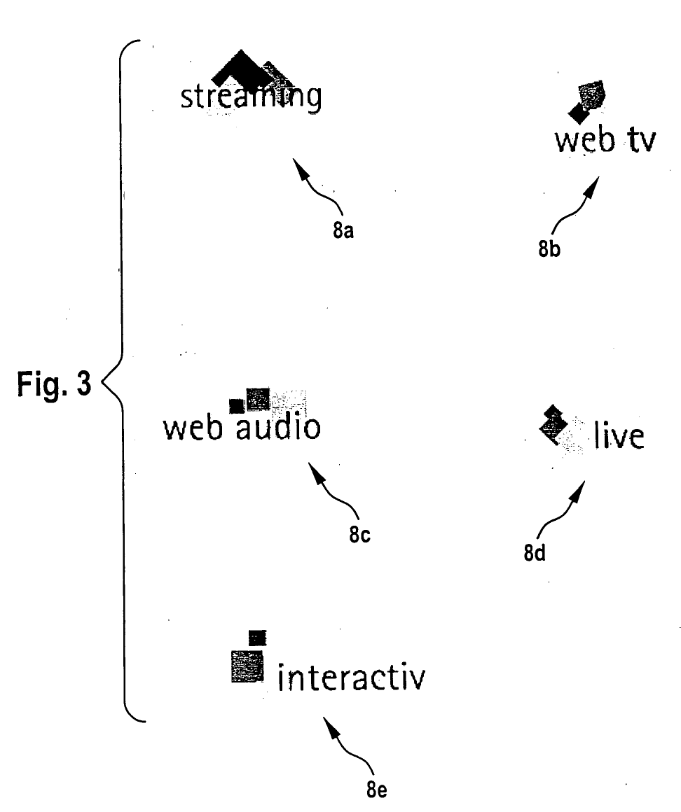

FIG. 3 shows a row of icons 8a, 8b, 8c, 8d and 8e that facilitate standardized user prompt. Clear and easily recognizable symbols used for identifying the stream type in the “streaming” area allows the user to know exactly in which portal area of the streaming area he is at the moment. Streaming symbol 8a “streaming” basically serves to identify the streaming material that is used for displaying multimedia data. It could also be icon “web television” 8b that signifies multimedia data derived from television broadcasts. Furthermore, it could be an icon called “web audio” 8c which signifies content from sound broadcasts. The streaming portal also offers the possibility to produce, in a studio, live broadcasts that are accessible either directly from the broadcasting and television program or from a program intended especially for the streaming portal. Such services are designated with icon “live” 8d. Interactive services are designated with the symbol “interactive” which also refers the user to chat rooms and other interactive uses of the streaming portal.

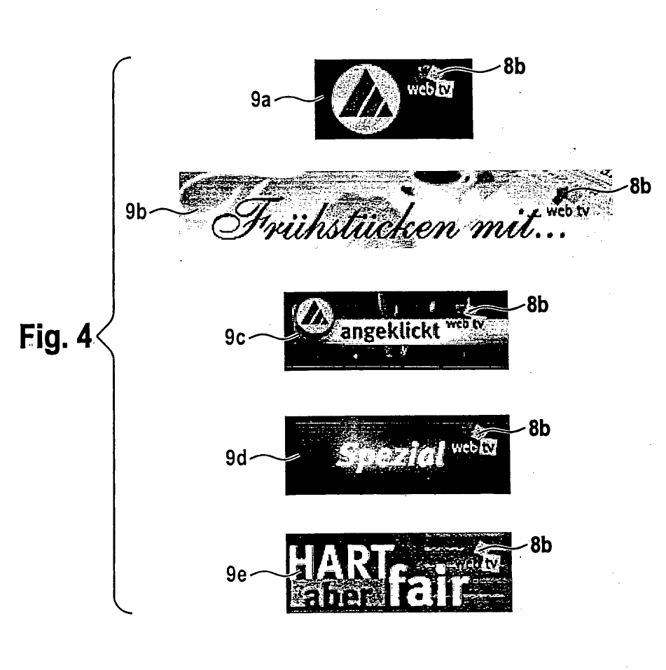

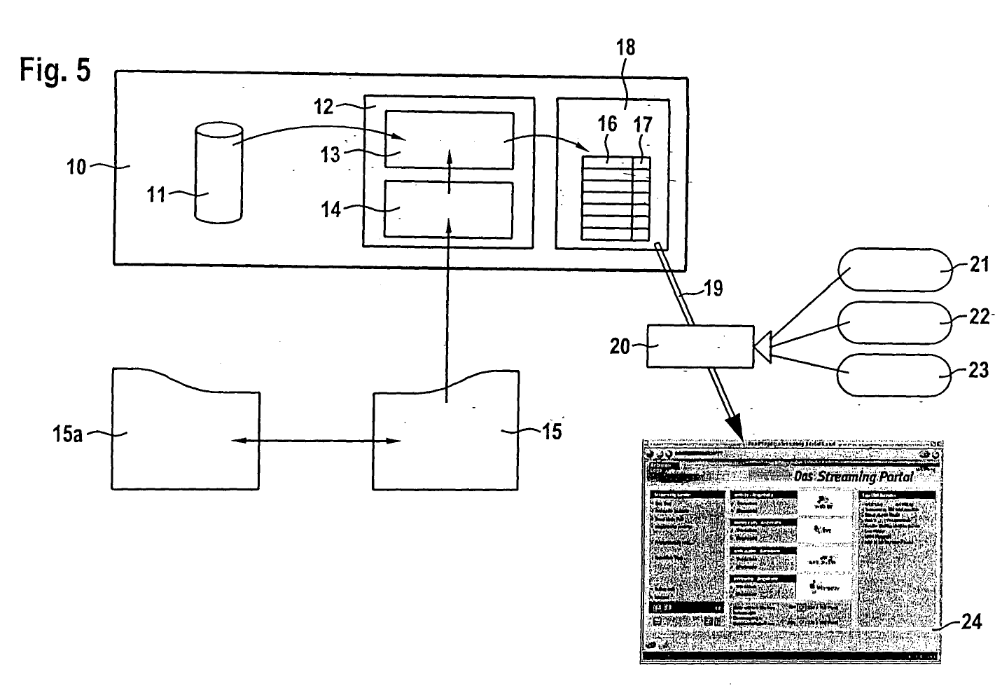

All broadcasts that are displayed on the streaming portal have their own “logos”. On the web they have been assigned an “icon” of the type described in FIG. 3. With this format consisting of a characteristic identifier, the multimedia data of the corresponding broadcast appear, ready to be fetched, on streaming portal 4 in a characteristic display frame that refers to the type of multimedia data contained in the streaming unit, the stream type and the information provider. A row of self-standing logos 9a, 9b, 9c, 9d, 9e appear as examples of logos in FIG. 4. In this example, every one of logos 9a to 9e has been provided with icon “web television” 8b since they refer to television material offered by the information provider. FIG. 5 shows a very simplified technical operating sequence that explains the joining of the multimedia raw data and the corresponding corporate design modular units, or in other words, the shown icons and logos and all the additional characteristic designs of the display frame that also identify the information provider.

The technical operating sequence includes a capture system 10. Firstly, raw data 11 from the multimedia data are made available to this capture system 10. These are usually analog-digital converted data that can be played back as a succession of data streams of which each basically corresponds to one unit of multimedia information, for example, a specific broadcast or bulletin in the form of a digital data stream. Multimedia raw data 11 can be made available in different ways. They could already be available in digital form and be transmitted to a corresponding storage media. They could also be accessed over the Internet. Additionally, it is possible to receive them via an antenna or a cable using a receiver. The raw data are provided with a configuration unit 12 from capture system 10 that has a hardware component 13 and a software component 14 that work together. Software component 14 performs a classification and marking of the multimedia raw data. The hardware components could be a PCI or other suitable card for a computer. Configuration unit 12 in the present example is provided with a show-view data file 15, and, as the case may be, additional data files containing Meta data that contain configuration data from the multimedia raw data. These configuration data in the form of show-view data files or other data files are available on network 15a, for example, the Internet. Show-view data file 15 basically contains information from the program offered by the information provider, such as, at least, the starting time, ending time and the channel. Based on the configuration information contained in show-view data file 15, the multimedia raw data is classified into a group of streaming units 16 and provided with a marking 17 identifying the type multimedia data contained in each of the streaming units. Marking 17 reveals what type of content streaming unit 16 contains in the form of multimedia data. This could, for example, include at least the complete identification of a broadcast including information such as type, name, time and channel. Marking 17 is, for example, contained in a header of streaming unit 16. Such a classified and marked configuration of multimedia raw data 11 is outputted by configuration unit 12 as a suitable data pool 18 and is made available for subsequent processing by capture system 10.

An advantage of this implementation is that additional Meta data are made available in additional data files. In this way, further identification of the broadcast also includes additional information regarding the performer, the director and production.

For example, the classification of multimedia raw data 11 could occur not only according to the time lapsed but also according to other criteria. In this regard, configuration data could be made available by means of the mentioned additional Meta data regarding a predetermined theme selection, a choice of performers and/or a choice of producers and/or directors in show-view data file 15 or additional data files. Furthermore, other data such as regional, linguistic or current criteria could be used to configure multimedia raw data 11 in the configuration unit 12. To this end, show-view data file 15 or other data files must have additional Meta data in accordance with the configuration data. Software 14 automatically performs the operation sequence just described. Naturally, the process can be influenced as, for example, the type of configuration data 15 could be changed. The subsequent processing 19 of the configured or, in other words, classified and marked multimedia data, occurs in a direction unit 20. It performs the automatic subsequent processing of the now prepared multimedia raw data 18 using direction software. Here it is, in particular, the addition of a corporate design to streaming unit 16 that occurs in accordance with marking 17 of a multimedia data 18 streaming unit 16. Depending on the type and content of marking 17, the streaming unit would, for example, be assigned a display frame that is characteristic of a certain corporate design 21, 22, 23. Predetermined corporate design modular units are suited for this purpose. The display frame would feature, for example, every type of corporate design modular unit 21, in other words, every type of design for the display frame design that is characteristic of the information provider and the type of multimedia data. It is, in particular, the information provider identifier that is used here. Furthermore, for a specific broadcast, streaming unit 16 could be equipped with a characteristic identifier for the type of multimedia data contained in each streaming unit such as an icon 22 or a logo 23, in accordance with marking 17. Direction and control unit 20 is responsible for joining, in accordance with identifier 17, display frame 21, 22, 23 and streaming unit 16. The processing 19 by direction and control unit 20 makes the streaming material that is ready for the streaming portal available in a suitable data carrier system, ready to be fetched, so that the streaming unit material can be fetched in a corporate design by way of streaming portal 24.

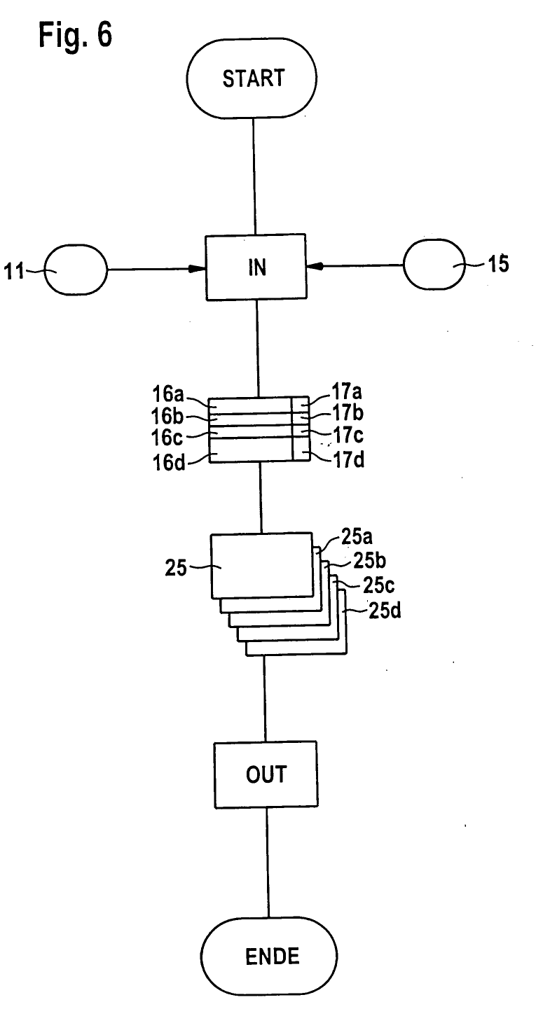

FIG. 6 shows the flow chart of the operating sequence shown above in FIG. 5. The automatic operating sequence joins multimedia raw data 11 and show-view data 15 at the “in” system using a capture system. The multimedia data are classified and marked, in other words, configured, and are displayed as a corresponding data file 18 as a group of streaming units 16a, 16b, 16c, 16d with corresponding markings 17a, 17b, 17c, 17d identifying the type of multimedia data that is contained in each of the streaming units. In accordance with markings 17a, 17b, 17c, 17d, in a subsequent step, each group of streaming units 16a, 16b, 16c, 16d is provided with an available corporate design and assigned display frame 25, which is characteristic of and/or identifies a streaming unit 16a, 16b, 16c, 16d both in its design and with the aid of other applications such as icons 8a to 8e or logos 9a to 9e. Using display frame 25a a user can, for example, very easily differentiate between the content of streaming unit 16a and that of another streaming unit 16b since streaming unit 16b has been assigned a differently designed frame 25b. This can be automatically done for any number of streaming units 16a, 16b, 16c, 16d and display frames 25a, 25b, 25c, 25d by means of direction and control unit 20. Naturally, it is also possible to quickly influence both the design of frame 25 and multimedia data 18 themselves using a maintenance system. In this manner, for example, new data could be added to the multimedia data for display on the streaming portal. Multimedia data could be deleted or further grouped if the automatic direction and control unit should require any variation. The output to an “out” system usually occurs on a client server, that a user can access.

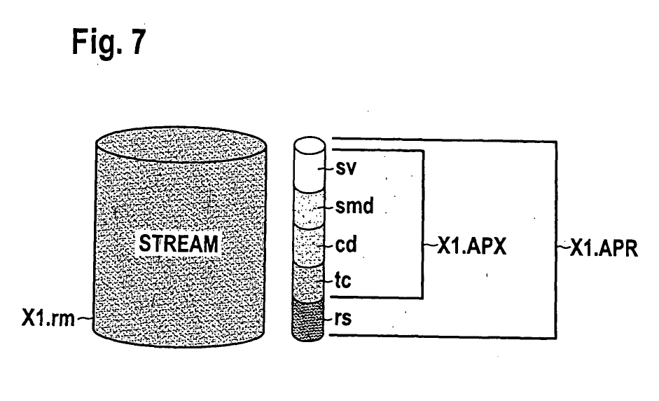

FIG. 7 shows the result of the disclosed operating sequence—namely a “live & on demand” stream data file for playback of a streaming unit in a display frame that identifies the type of multimedia data contained in the streaming unit and the information provider. A concrete process sequence of a streaming content producer to generate the “live & on demand” stream data file is described below.

Flow chart of a SCP (Streaming Content Producer) for a “live & on demand” stream data file:

| | | | |
|---|---|---|---|
| 1. | Input: Film title = | X1 | |
| 2. | Input: Show-view Code (SV) with VPS = | X1.SV | Show-view data file |
| | or single input start, end, channel. | | |
| 3. | Input: Super meta data (SMD) such as, = | X1.smd | Super meta data data file |
| | direction, producer, actor and so forth. | | |
| 4. | Input or choice: Corporate design (CD) = | X1.cd | Corporate design data file |
| 5. | From the system time (radio clock) a real = | X1.tc | Time Code data file |
| | time time code (TC) is determined after start | | |
| | and stop according to SV and stored as X1.tc | | |
| 6. | All entries are written as X1.APX as a TXT = | X1.APX | Appendix data file |
| | or CSV file on a network storage unit. | | |
| 7. | The streaming content producer starts and = | X1.rm | RealMovie data file |
| | stops the input according to X1.sv and is stored | | |
| | on the network storage unit as X1.rm or is sent | | |
| | directly to a dynamic server as an IP data | | |
| | stream. | | |
| 8. | For a navigable X1.rm the appendix data file = | X1.rs | Appendix data file |
| | X1.APX is expanded to include editorial data | | |
| | (RS) such as, for example, chapter, scripts, | | |
| | links, graphics and so forth and is written on a = | X1.APR | Appendix data file |
| | network storage unit as X1.APR | | |
| 9. | Now an X1.smil application can be = | S1.smil | Stream data file |
| | automatically generated from the available data | | |
| | X1.APX and the video data file X1.rm or an | | |
| | X1R.smil application from the X1.APR data | | |
| | and the video data file X1.rm. | | |

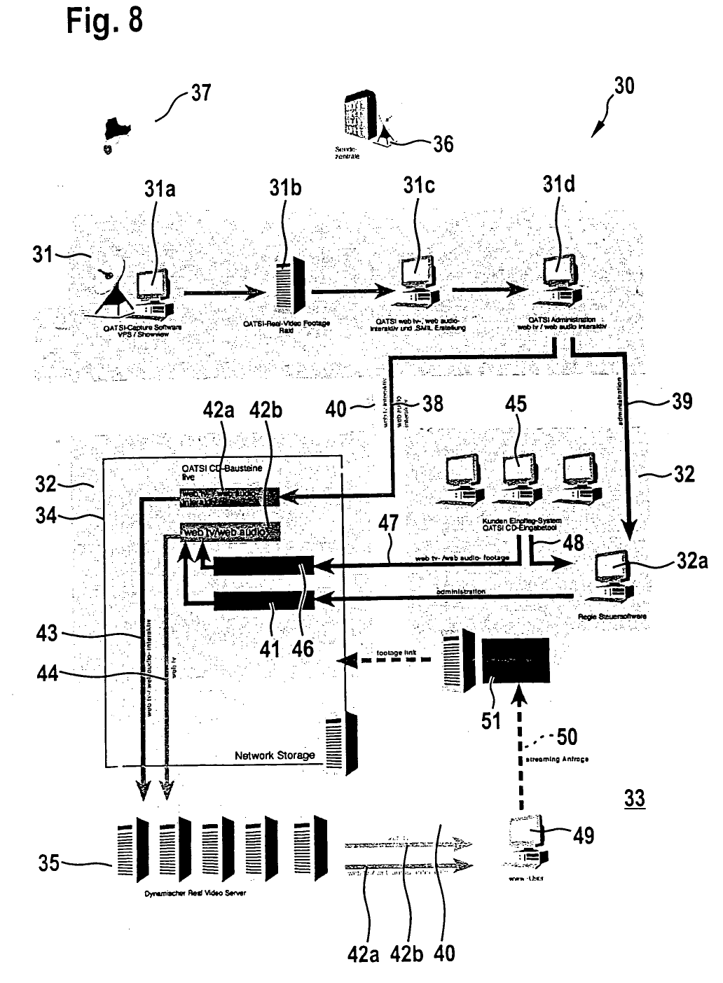

Input in the above used sense can mean a manual input. However, advantageously input means an automatic read-in from an available data pool. Such a data pool is preferably manually or automatically loaded and updated by means of a maintenance system. The read-in occurs using a computer system in a computer network. This is explained in further detail in FIG. 8.

Prior to the performance of the above described operation sequence, the configuration of the multimedia information to be processed is entered. The configuration data are made available in accordance with point 1 to 3. Here, a time code data file and an appendix data file are used in accordance with points 5, 6 and 8. The classification and marking of the multimedia data using the configuration data could occur according to point 7. Additionally, appendix data files and RealMovie data files are distributed side by side and/or will refer to each other in a suitable manner. The appendix data file or content thereof could also be accommodated in a header of the RealMovie data file. In accordance with point 9 the streaming unit is played back as a data stream in a display frame that identifies the type and the information provider using corporate design data file.

Generators controlled by scripts join multimedia data and CD modular units. In this connection, an X1.smil, or as the case may be, an X1R.smil is generated using the following components:

a) File named X1,

b) in this file, subfile for audio, video, clip art, graphics, texts, web links and the X1.smil, or as the case may be, the X1R.smil data files

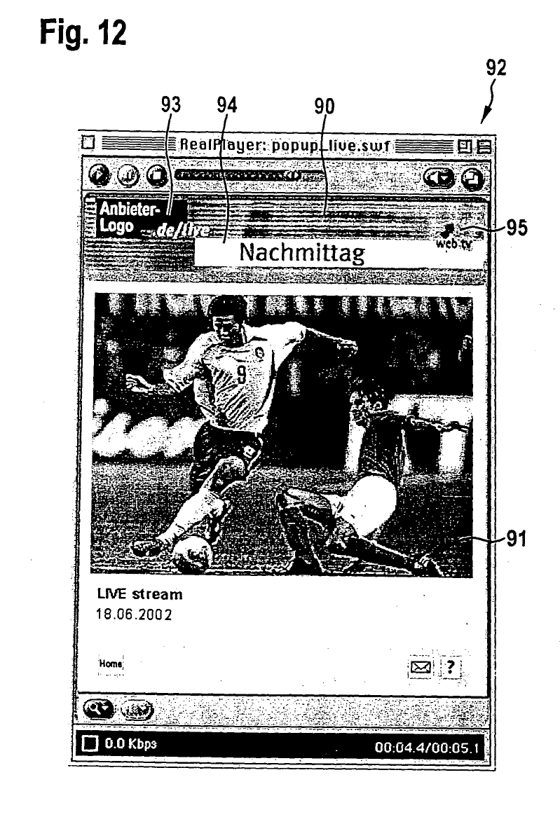

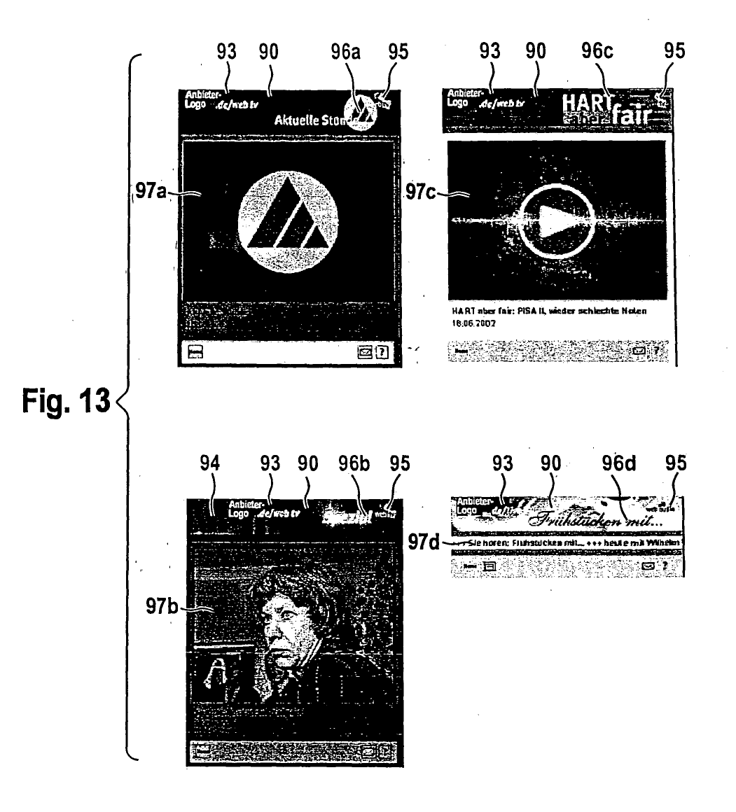

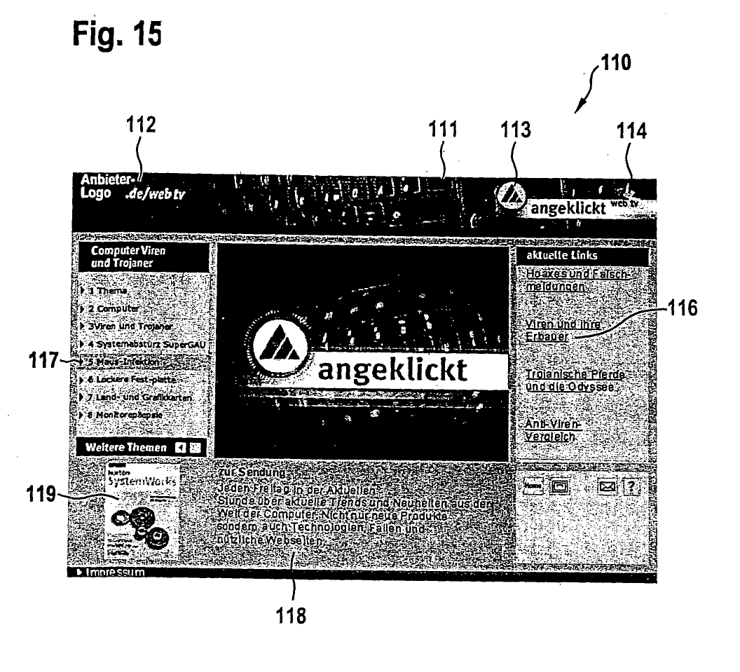

An X1.smil data file supplies a “live” data file that is suitable for displaying this streaming unit in the corporate design. Examples of such data files are shown in FIGS. 12 and 13. An X1R.smil data file comprises an additional editorial process that, for example, contains additional texts and links. Examples of such data files are shown in FIGS. 15 to 18. An X1R.smil data file is particularly suitable for displaying a display frame since it allows playback at a precise time and location of specific information or of an identifier at a pre-determined time period, in a suitable way.

For the example described above, the RealFormat for streaming data files is suitable. Other formats for streaming units can also be used if necessary.

The result is a video live stream with corporate design and comprehensive Meta data, in other words, a navigable “live & on demand” stream with additional information and links.

An appendix data file of the type described above is preferably also made available for a yet to be outlined user system, for example, a home recorder. In this manner, a user has at his disposal all show-view and Meta data to create a personal display choice. The content and the scope of an APX data file greatly extend beyond common show-view codes (broadcast time and channel). The storage capacity of an APX data file is practically unlimited, which means that it can contain detailed information and configuration data pertaining to a data stream.

FIG. 8 shows a schematic view of a particularly preferred embodiment of a computer network that advantageously is suitable for the provision of the operating sequence of a streaming content producer described in FIGS. 5 to 7 that supplies the streaming portal according to the example shown in FIGS. 2 to 4. The computer network with peripheral hardware and software is the streaming content producer. The preferred embodiment of computer network 30 comprises a first computer system in the form of a capture system 31, a second computer system in the form of a peripheral system 32 as well as a third computer system in the form of a user system 33. The peripheral system comprises a first server unit 34 that serves as client server. On this client server 34 the client has access from his user system 33 via a footage link server 51. To ensure quick conversion and fast availability of the multimedia data on the streaming portal, t is preferable if all the multimedia data for display on the streaming portal are distributed on a dynamic RealVideo server 35. It has the necessary capacity and performance to make available all the multimedia data of the streaming portal in a sufficiently efficient manner. Below is a detailed description of a particularly preferred embodiment of a first computer system in the form of a capture system 31, a second computer system in the form of a peripheral system 32 with a client server 34 and a dynamic RealVideo server 35 as well as a third computer system in the form of a user system 33 within the framework of computer network 30.

The multimedia information is made available to cpture system 31 via a transmitting central 36, in this case via a satellite 37, by way of a corresponding receiver 31a that is operated by way of capture software especially developed for this purpose. Receiver 31a is able to read out a VPS or show-view format in such a manner that the multimedia data configuration from the program offered by the information provider is determined and made available as configuration data, in this case, as a show-view data file. The multimedia information for the streaming portal is first converted from digital to analog by a conversion unit and made available as a group of data streams. Capture system 31 also comprises a RealVideo footage raid 31b as well as a SMIL writing unit 31c. Using hardware 31b, 31c and the SMIL software, the multimedia data is classified into groups of streaming units on the basis of the configuration data and every group of streaming units is marked with an identifier that identifies the type of multimedia data contained in each streaming unit. The capture system is controlled by an administrator unit 31d. Data pool 18 of configured, classified and marked streaming units shown in FIG. 5 is made available for peripheral system 34 via administrator unit 31d.

For this purpose, corresponding data lines 38 and 39 are provided. An additional data line 40 connects RealVideo footage raid 31b directly with dynamic RealVideo server 35 for transmission of live data. First data line 38 transmits the content of data pool 18 to client server 34. In this process, the data is divided up into three separate data flows for web television, web audio/interactive and interactive. Second data line 39 makes available corporate design modular units from the direction and control unit 32a of the peripheral system to characterize the content of data pool 18. Furthermore, it provides important information and control instructions for administration purposes. By means of direction and control software of the unit 32a, corporate design modular units 41 are added from data pool 18 to the streaming units 16 in accordance with their identifier 17 (FIG. 5). The control occurs by means of an administration channel 39. At this point, a classification of the data flow depending on the type of streaming unit could already take place into television/audio or interactive 42a, 42b groupings. In the present example of an embodiment it has proven advantageous if the television/audio and interactive share of the multimedia data are led into separate data lines 43 and the television share is led into an additional data line 44. On dynamic RealVideo server 35 the television/audio and interactive streaming units that now have corporate design modular units are made available via line 43. The television content is also provided with corporate design modular units 41 and made available via data line 44. Furthermore, all footage data including, in particular, live data are available for RealVideo server 35 via data line 40. In this manner, the group of streaming units are available for playback by means of a data stream in a display frame that identifies the type of multimedia data contained in each streaming unit and the information provider either on dynamic RealVideo server 35 or on client server 34.

The particularly preferred embodiment of the computer network described here also comprises a maintenance system 45 within the frameworks of the peripheral system. By means of maintenance system 45 current multimedia raw materials can be made available as footage material 46 by means of a separate data line 47.

Furthermore, the direction and control software can be influenced via a data line 48. Client maintenance system 45 is chiefly used to adjust the corporate design, in other words, within the framework of peripheral system 32 by means of the maintenance system, the client is able to adjust his corporate design as it is used by the direction and control unit 32a, to conform to current needs. For this purpose, the client could, for example, supplement, change or exchange the corporate design modular units shown in FIG. 5.

According to a variation the capture system could also comprise a unit that is similar to units 32a, 45 that data technically joins multimedia raw data and corporate design modular units for a finished streaming unit that can be played back on the streaming portal as a data stream. The peripheral system would thus no longer be responsible for this task.

Within the framework of his user system 33, a client now can access client server 34 by means of, for example, a multimedia personal computer 49. For this purpose, an Internet connection 50 for streaming inquiries is available on streaming portal 51. In the current embodiment it is connected to a footage link server. Depending on the type of inquiry, a corresponding data flow is released via streaming portal 51 and client server 34 from dynamic RealVideo server 35 to client portal 49. This could be an interactive data flow 42a. Furthermore, a web television data flow 42b could also be released. If necessary, additional data or additional multimedia data that are not intended for use for playback in a corporate design can be made available for multimedia personal computer 49 via a data line 40. However, usually every display occurs in a corporate design.

Preferably, data lines 42a, 42b and 40 are adjusted in accordance with the data that is to be transmitted. There are many different possibilities for data transmitting. In a variation of the preferred embodiment described here it is possible to design the user system to be a mobile system. Instead of a multimedia personal computer 49, a mobile telephone could also be used to make inquiries on streaming portal 51 and for the receipt of multimedia data from dynamic RealVideo server 35. In an additional variation, a permanently installed base station with permanent data lines 40, 42b and 42a to dynamic RealVideo server 35 could be used instead of multimedia personal computer 49. In this case, a data line 40, 42b and 42a depending on the requirements of the data to be transmitted (television/audio/interactive or television or footage) could be generously dimensioned. The currently described implementation uses a multimedia personal computer 49, that, for example, could be a home computer in a private home that is connected to dynamic RealVideo server 35 via Internet connection 40, 42b, 42a.

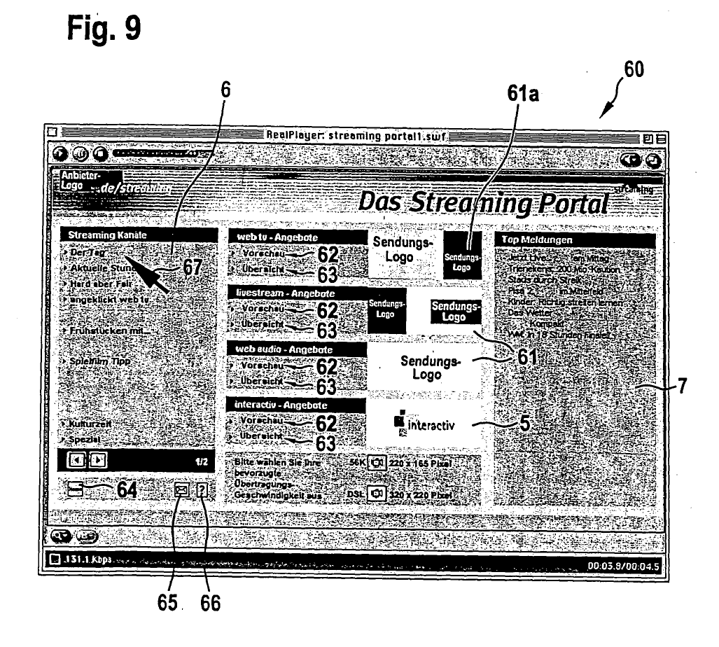

The following is an example of navigation on the streaming portal in accordance with the preferred embodiment by way of FIGS. 9 to 12, describing how a streaming inquiry to streaming portal 60 could occur. Basically, streaming portal 60 that is shown in FIG. 9 corresponds to streaming portal 4 already shown in FIG. 2. As is shown in FIG. 2a list of streaming channels 6 as well as news headlines 7 are accessible. Additionally, there are various choices for web television, live stream, web audio and interactive. The multimedia content of these choices is made available for playback as data streams in accordance with a process, such as for example, the process described in FIGS. 5 to 7 as well as within the framework of a computer network, such as, the network described in FIG. 8.

Similar to home page 4 of the streaming portal shown in FIG. 2, home page 60 of the streaming portal shown in FIG. 9 has an icon 5 among the interactive choices (such as, 8a to 8e in FIG. 3) that is the unambiguous symbol for “Streaming” in the interactive portal. For any additional choices it is possible to use a scrolling list 61 to visually see a detailed content list in the form of logos such logo 61a (such as, one among 9a to 9e in FIG. 4). When the user wants to see, for example, the choices offered under “Web television” he clicks on “Overview” 63 and all the choices available for this area are shown in list 61 that includes recognition factors. This selection option using logo 61a appears instead of the icon symbol 5.

The user can directly choose the desired broadcast 6. For example, he could choose “The day” under “Streaming channels”. Here he could also make regional choices, such as “The day in NRW” or “The day in Bayem”. Additional channels can be chosen from additional “Streaming channel” pages.

The user can also click directly on “Top stories” 7 and will jump directly to the material available for the corresponding broadcast.

The user can also first check things out and click on “Overview” 62 among the “Streaming choices”. A broadcast can also be directly accessed from the overview by clicking on it.

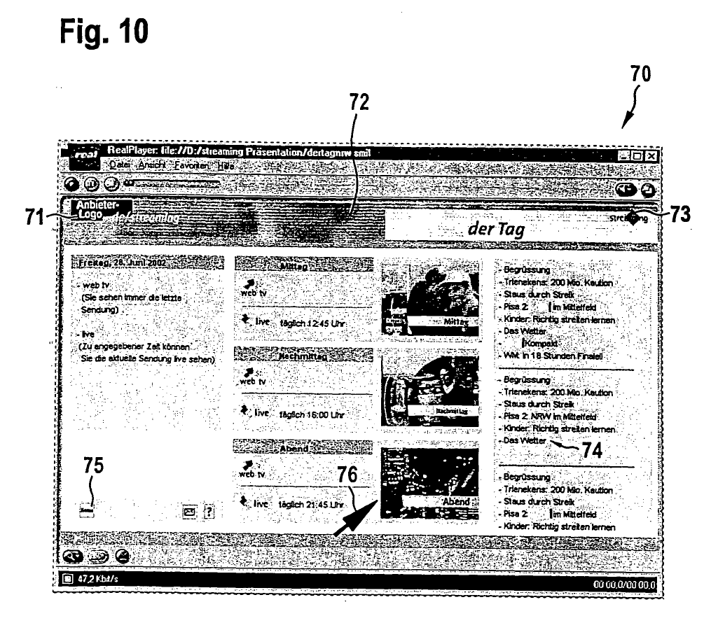

The entry requirements with regards to transmission speed is only necessary on the home page unlike on already known versions of an Internet page. In this case, a DSL or 56 K setting is available. In this manner, the user already at this point has access to the entire multimedia content of the information/broadcasting/television broadcaster. This is almost the equivalent of having access to your own television broadcaster that, however, contains data beyond the multimedia data available for the usual television or sound broadcast programs. This is described in further detail below by means of FIGS. 10 to 12 within the framework of the navigation example.

By clicking on “Home” 64, the user returns to the home page of the broadcasting and television provider. Furthermore, there is a “Mail” 65 and a “Help” 66 link on the home page. The help link concerns, for example, the optimal computer setting, additional information regarding the streaming portal, troubleshooting and similar links.

In the current navigation example, the user wishes to access the news from NRW and from the choices under “Streaming channels” he chooses “The day in NRW”. To this end, he clicks with his mouse 67 on the appropriate menu item.

Thereafter, as is shown in FIG. 10, the user gains access to the next page 70 of the streaming portal with the title “The day in NRW” displayed in the information provider's corporate design 71 and with a design 72 that identifies the broadcast using consistent streaming symbols 73. This combination is based on the technical joining of multimedia raw data and footage material as well as corporate design modular units in accordance with the process depicted in FIGS. 5 to 7 within the framework of a capture and peripheral system as shown in FIG. 8.

The user can now view the “Headlines of the day” on the right side of the display frame at a glance. Equally so, the user can directly pick out one “Headline”. The choice 74 “The weather” would let the user go directly to the appropriate location in the broadcast. When clicking on “Home” 75 the user returns to home page 60 (FIG. 9) of the portal. In the present navigation example, the user clicks directly on a broadcast within the framework of “NRW at midday”. This is indicated by mouse 76.

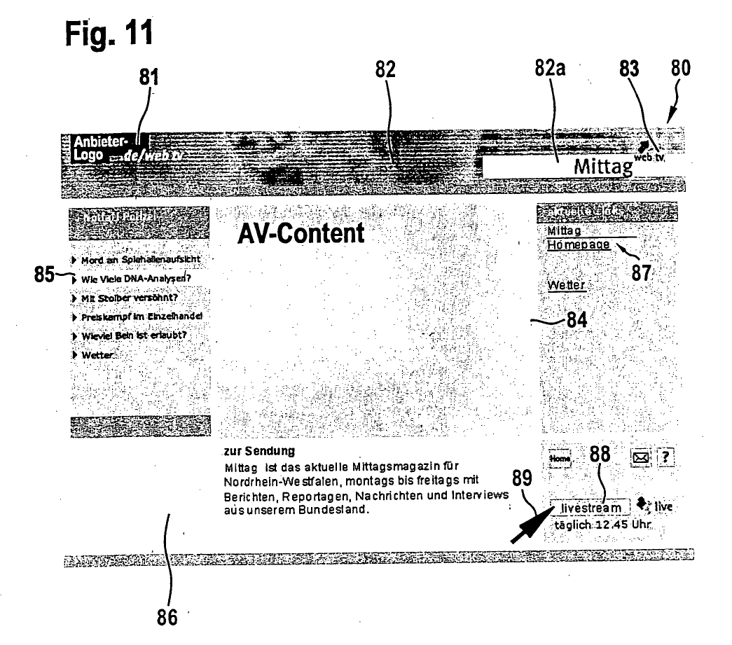

The next page 80 of the streaming portal is shown in FIG. 11. It is the corresponding page of the broadcast “NRW at midday”. This page, too, is shown using the information provider's corporate design 81. In this case, it is a logo 82a that identifies the broadcast and the audio visually designed layout 82 of the entire page as well as consistent symbols used to designate web television 83. Such a design is usually automatically generated by direction and control device 32a described in FIG. 8. However, it could also be realized by means of maintenance system 45 described in FIG. 8. Furthermore, capture system 31 shown in FIG. 8 could be the standard system made available to such a display method.

On page 80, themes 85 of broadcast 84 can be directly accessed. Graphics (not shown), texts 86 and links 87 could be offered as additional data beyond multimedia data 84 accompanying (CC synchronous) film 84. If the broadcast is clicked on, for example, just after 16:00 o'clock, “Live stream” button 88, shown in the present implementation, blinks. In this way, the user can directly access the current live broadcast from user portal 49 shown in FIG. 8.

In the present navigation example, user has clicked on the “Live stream” button 88 with his mouse 89.

FIG. 12 shows live stream 91 chosen by the user. It is displayed for the user by means of a playback tool 92 that controls the live stream. As shown in FIG. 1 in item 3 the difference from the current display methods of a live stream is that in the present navigation example (FIGS. 9 to 12) the live stream is played back for client server 34 in the form distributed on dynamic RealVideo server 35 in FIG. 8 in a display frame 90 with the information provider's corporate design 93 and with a design 94 that identifies the broadcast as well as with consistent symbols 95 denoting stream type.

The navigation example shown in FIGS. 9 to 12 makes clear that only by means of the concept for a computer network disclosed here and a process for providing the described streaming portal could a streaming unit be played back as a data stream in a display frame that identifies the type of multimedia data and the information provider. Furthermore, this navigation example shows that in accordance with the preferred embodiment the data on the streaming portal can be played back on a display frame that has been designed to play back all the data and that identifies the information provider.

The playback of information material in a corporate design is of great benefit to the information provider when displaying audiovisual media. The streaming choices could be better presented. The potential for re-use of broadcasting material as streaming content can be improved by supplementing it with additional multimedia information and links. Furthermore, the logistics and the technical execution of the suggested concept are simple and efficiently structured. In the suggested concept an Internet television is practically transformed into a format that is characteristic of the information provider using available multimedia information.

FIG. 13 shows additional examples of display frames 90 than were shown in FIG. 12, however with a different content but with corresponding identifiers. In all the examples 90, the information provider's corporate design 93 is present, in other words corresponding logo, layout, trademark or a certain color. Other information providers are to a certain extent also identified with a separate corporate design 94. The logo denoting a corresponding broadcast 96a, 96b, 96c, 96d is provided in every multimedia window 90. Furthermore, the consistent symbols 95 characterize the type of streaming units as web television. The streaming units display each of the broadcasts 97a, 97b, 97c, 97d denoted with symbols 96a, 96b, 96c, 96d as data streams. Data stream 97d is different since it is an acoustic sound broadcast.

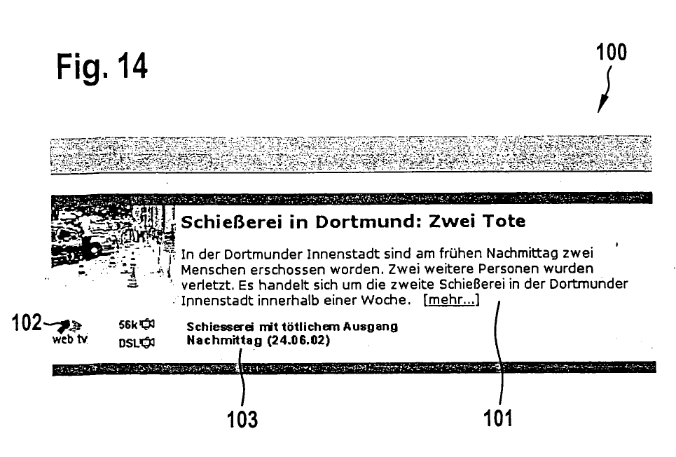

FIG. 14 shows that the consistent use of homogeneous symbols for streaming content is particularly advantageous, since the user knows what choices to expect from each symbol. In a particular example, all of the icons in FIG. 3 correspond to a data flow/data channel practically provided especially for it. A selection of those would, for example, be data channels 42a, 42b and 40 described in FIG. 8. A normal HTML page 1100 from FIG. 13 shows the already mentioned icon 102, preferably next to a data content in display form 101 in which it is known on common web pages, as a consistent symbol and as reference to television material in conjunction with title 103 of a streaming portal as is described in FIGS. 2 to 13. In this manner, a link between the streaming portal and the Internet can be provided. If you click on icon 102 designated “Web television”, the user is granted access to information about the current theme by way of the streaming portal. The user will use default settings on home page 60 (FIG. 9) with regard to system requirements, RealPlayer, downloads and other computer settings such as troubleshooting.

FIG. 15 shows a display page 110 with a characteristic display frame 111 consistent with the one just described with corresponding applications 112 for the information provider, applications 113 for the broadcast and application 114 for consistent symbols. Additionally, not only is corresponding broadcast 115 shown but also additional links 116, themes from broadcast 117 as well as additional information 118, in this case a complementary book 119.

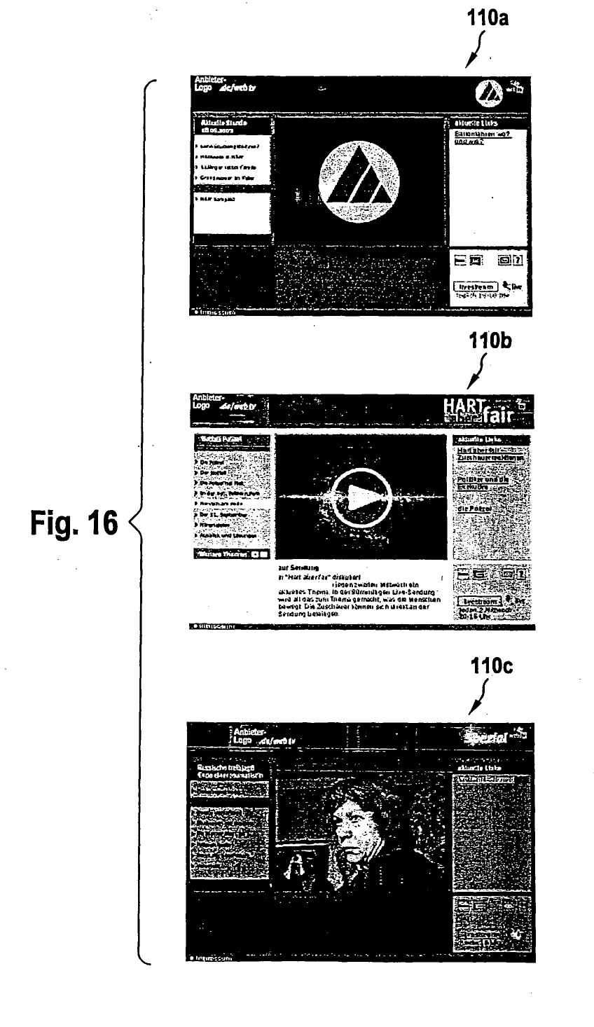

Other examples thereof can be seen in illustrations 110a, 110b, 110c as shown in FIG. 16.

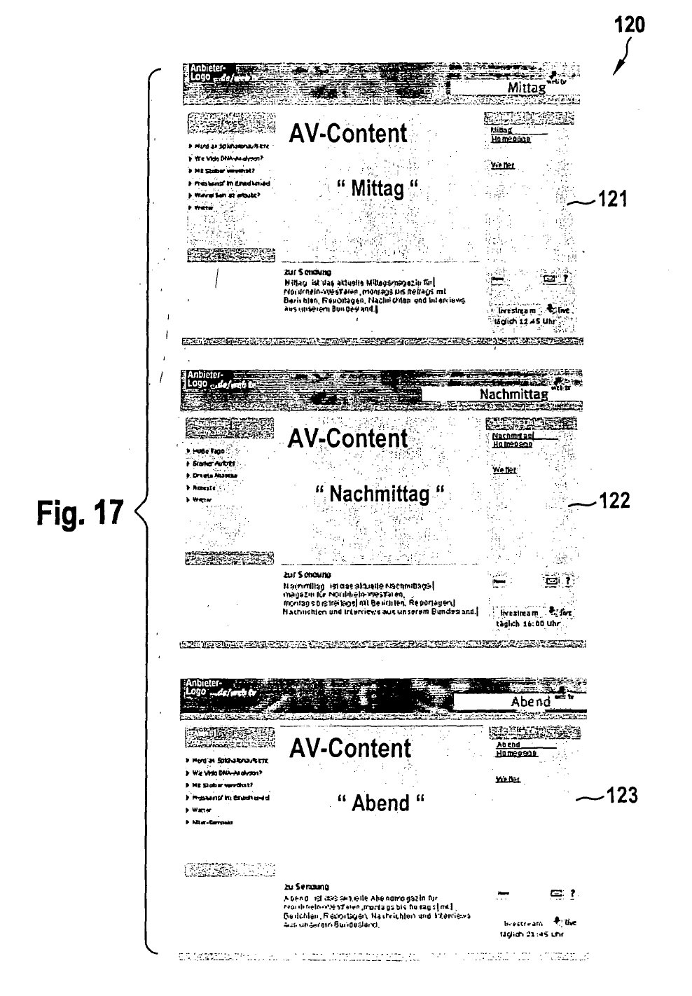

Additional streaming portal display pages could be grouped according to, for example, a time criteria. Such a group of pages 120 is shown in FIG. 17 by means of the broadcast “NRW”. Group 120 comprises a group of display frames 121, 122, 123 that have been classified and assigned to a local intended for the NRW broadcast. The grouping relates to the time sequence of the broadcasts “NRW at midday” 121, “NRW in the afternoon” 122 and “NRW in the evening” 123. For grouping 120, a corresponding characteristic design is assigned to the NRW broadcast. An additional form for grouping could include displays from different cities in the region such as, for example, “From Dusseldorf”. A grouping of display pages such as the one shown in FIG. 17 has already been assigned by a capture system 10 to a streaming unit 16 within data pool 18 in accordance with marking 17 as is shown in FIG. 5. A corresponding data conversion occurs either in capture system 31 or in a direction and control unit 32a of peripheral systems 32 from FIG. 8, or in a maintenance system 45 of peripheral systems 32 as seen in FIG. 8, when changes are required to be made to corporate design modular units 41 from FIG. 8.

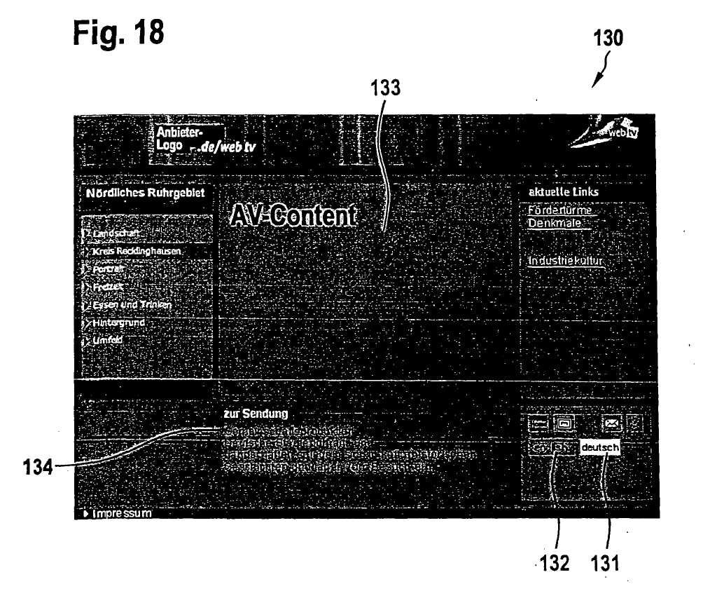

FIG. 18 shows an example of a display frame 130 that could be multilingual, in other words, in this case German 131 and/or English 132. For example, during the operation sequence of broadcast 133 it is possible that an English translation of the broadcast is displayed in text window 134. This is particularly advantageous for Europe wide magazines that, for example, have to be displayed in German/English, German/French, German/Dutch or German/Luxemburg French.

In the above specifications, a self-contained web broadcaster, in other words, a “television on the Internet” is described. It basically comprises a streaming portal on a user or multimedia personal computer, cell phone or on a base station. A computer network in accordance with FIG. 8 supplies the web broadcaster and works in accordance with the process described in FIGS. 5 to 7. In this manner, either already existing broadcasts and television content could be established on the web broadcaster or modified broadcasts that are especially intended for the web broadcaster could be produced. Broadcasting material on the web broadcaster can be commented on or additional information in normal multimedia format can be added as desired. Additionally, it is possible to produce live broadcasts especially for the web broadcaster by way of the capture system that to this end, for example, could comprise a corresponding broadcasting unit. The streaming portal itself is built up on the modular pattern and facilitates access via a home page to additional display frames from which multimedia streaming units can be fetched. The display frames can be grouped according to different categories that already have been predetermined by means of a program from an information provider when the data is configured and automatically converted by means of a control and direction unit. To this end, configuration material such as finished flow charts, texts, links and other configuration material that, for example, also could be supplied via the Internet or e-mail are used. Maintenance systems facilitate adjustment of the configuration data as well as the multimedia data themselves on the streaming portal. The object of providing multimedia raw data with a corresponding corporate design is achieved in an effective and automatic manner by means of a capture system, a peripheral system and a user system with a consistent navigation concept for the user. In this connection, a user system could also be a suitable home recorder. Upgrades involving cellular mobile telephony are also possible. A mobile telephone user console or remote control of a stationary user console or a home recorder by means of the mobile telephone is particularly useful for this purpose.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A streaming portal, comprising:
at least one display frame for playback of multimedia information from a program offered by an information provider whereby the multimedia information is made available as multimedia data and the multimedia data are played back as a group of data streams;
wherein the multimedia data are divided into a group of streaming units on the basis of the configuration data determined from the program, whereby a streaming unit is supplied with a label that identifies the type of multimedia data contained in the streaming unit and the streaming unit is supplied with a display frame that identifies the information provider and is played back as a data stream.

2. The streaming portal of claim 1, wherein the multimedia data is intended for playback on the streaming portal in a display frame that has been designed to play back all the data on the streaming portal and that identifies the information provider.

3. The streaming portal of claim 1, wherein the program is a television or broadcasting program.

4. The streaming portal of claim 1, wherein the program contains a group of predetermined criteria for the determination of the configuration data.

5. The streaming portal of claim 4, wherein the criteria comprise at least one of time, theme, performer, producer, director, local criteria, language, and topicality.

6. The streaming portal of claim 1, wherein the display frame is fitted with at least one identifier.

7. The streaming portal of claim 6, wherein the at least one identifier comprises at least one of design of the display frame, icon for the type of stream, and icon for the type of multimedia data.

8. The streaming portal of claim 1, further comprising a home page that has a menu including at least one of streaming channels, television, live stream, audio, interactive services, and latest news.

9. The streaming portal of claim 1, further comprising a link to the Internet.

10. The streaming portal of claim 1, wherein a display frame assigned to each program broadcast also includes a link that provides access to the multimedia data that corresponds to the broadcast and which extends beyond the content of the broadcast.

11. The streaming portal of claim 1, wherein a number of display frames is grouped and assigned to a broadcast, whereby the grouping has a design that characterizes the broadcast.

12. The streaming portal of claim 1, wherein at least one display frame is multilingual.

13. A computer device comprising the streaming portal of claim 1.

14. A process for providing a streaming portal with at least one display frame for playback of multimedia information of a program offered by an information provider, comprising:
making the multimedia information available for the streaming portal as multimedia data;
making the multimedia data available for playback as a group of data streams, wherein
determining a configuration of the multimedia information from the program and is made available as configuration data;
dividing the multimedia data into a group of streaming units of the configuration data;
marking a streaming unit with an identification of the type of multimedia data contained in the streaming unit; and
providing the streaming unit with a display frame for playback as a data stream that identifies the information provider.

15. The process of claim 14, wherein the multimedia data on the streaming portal is played back on a display frame designed to play back all the data on the streaming portal and that identifies the information provider.

16. The process of claim 14, wherein the multimedia information is made available for the streaming portal as a receiver receives the multimedia information for the streaming portal.

17. The process of claim 16, wherein the multimedia information is made available by way of at least one of an antenna and a cable receiver and is converted to digitized information material in the form of multimedia data in a conversion unit.

18. The process of claim 14, wherein at least one of additional multimedia data and additional data is made available via at least one of a data storage unit and a network.

19. The process of claim 14, wherein the program is made available together with the multimedia information.

20. The process of claim 14, wherein the marking occurs in a stream unit header.

21. The process of claim 14, wherein the program is made available separately from the multimedia information.

22. The process of claim 21, wherein the program is made available via a network.

23. A computer program product that can be stored on a computer readable media and be fitted with a software code segment for initiating a computer device for playback of multimedia information of a program offered by an information provider on the streaming portal of claim 1 when the product is implemented on the computer device.

24. A computer program product that can be stored on a computer readable media and is fitted with a software code segment for initiating a computer device for implementation of the process of claim 12 when the product is implemented on the computer device.

25. A computer readable media on which the computer program product of claim 23 is stored.

26. A computer readable media on which the computer program product of claim 24 is stored.

27. A computer network for providing a streaming portal with at least one display frame for playback of multimedia information from a program offered by an information provider, comprising:
a receiver via which the multimedia information is made available;
a conversion unit via which the multimedia information becomes available as multimedia data whereby the multimedia data are played back as a group of data streams; and
at least one computer system,
wherein a configuration of the multimedia information determined from the program is made available as configuration data,
wherein the multimedia data can be divided into a group of streaming units on the basis of the configuration data,
wherein at least on of the streaming units has a marking that identifies the type of multimedia data contained in the streaming unit, and
wherein at least one of the streaming units is provided with a display frame that identifies the information provider.

28. The computer network of claim 27, wherein the multimedia data on the streaming portal can be played back on a display frame designed to play back all the data on the streaming portal and that identifies the information provider.

29. The computer network of one of claim 27, wherein the streaming units are grouped into categories based on at least one of streaming, audio, interactive, live, and television services.

30. The computer network of 27, wherein a data transmission occurs into data flows that have been separated into categories.

31. The computer network of claim 27, wherein a data transmission occurs via at least one of the Internet, a LAN, and a WAN.

32. The computer network of claim 27, further comprising a broadcasting unit for the execution of live broadcasts.

33. A computer system that provides a streaming portal with at least one display frame for playback of multimedia information from a program offered by an information provider, the first computer system comprising:
a receiver via which the multimedia information is made available; and
a conversion unit via which the multimedia information become available as multimedia data,
wherein the multimedia data are played back as a group of data streams,
wherein the computer system is a capture system,
wherein a configuration of the multimedia information determined from the program is made available as configuration data,
wherein the multimedia data can be divided into a group of streaming units on the basis of the configuration data, and
wherein at least one streaming unit has a marking that identifies the type of multimedia data contained in the at least one streaming unit in such a way that the at least one streaming unit is provided with a display frame that identifies the information provider.

34. The computer system of claim 33, wherein the capture system comprises:
capture software;
a RealVideo footage raid;
a SMIL software creator; and
an administrator unit.

35. A method of using a computer system for providing a streaming portal with at least one display frame for playback of multimedia information of a program offered by an information provider, comprising:
making the multimedia information available for the streaming portal as multimedia data; and
making the multimedia data available for playback as a group of data streams,
wherein the computer system is designed as a capture system,
wherein a configuration of the multimedia information is determined from the program and is made available as configuration data,
wherein the multimedia data are divided into a group of streaming units of the configuration data,
at least one streaming unit is marked with an identification of the type of multimedia data contained in the at least one streaming unit, so that the at least one streaming unit for playback as a data stream is provided with a display frame that identifies the information provider.

36. A method of using a computer system for providing a streaming portal with at least one display frame for playback of multimedia information of a program offered by an information provider, comprising:
making the multimedia information available as multimedia data;
making the multimedia data available for playback as a group of data streams;
dividing the multimedia data into a group of streaming units of the configuration data from the program whereby at least one streaming unit is marked with an identification of the type of multimedia data contained in the at least one streaming unit,
wherein the computer system is a peripheral system in which the streaming unit is provided with a display frame that identifies the information provider.

37. The method of claim 36, wherein the peripheral system is fitted with a first server unit for playback of the streaming portal that is designed as a link unit and is used for the execution of streaming requests.

38. The method of claim 36, wherein the peripheral system is connected to a second server unit that is a dynamic RealVideo server and is used to implement tasks.

39. The method of claim 38, wherein the tasks comprise at least one of administration, storage, and execution of multimedia data for the first server unit.

40. The method of claim 36, wherein the peripheral system comprises a maintenance system fitted with input tool software.

41. The method of claim 36, wherein the peripheral system comprises a management and control unit.

42. A method of using a computer system for providing a streaming portal with at least one display frame for playback of multimedia information of a program offered by an information provider to which the multimedia information for the streaming portal is made available as multimedia data, comprising:
making the multimedia data available for playback as a group of data streams;
dividing the multimedia information into a group of streaming units of the configuration data from the program;
marking at least one streaming unit with an identification of the type of multimedia data contained in the streaming unit; and
using the computer system as a peripheral system in which the at least one streaming unit is provided with a display frame that identifies the information provider.

43. A computer system for providing a streaming portal with at least one display frame for playback of multimedia information of a program offered by an information provider to which the multimedia information is made available as multimedia data whereby the multimedia data are made available for playback as a group of data streams,
wherein the multimedia data is divided into a group of streaming units of the configuration data from the program whereby at least one streaming unit is marked with an identification of the type of multimedia data contained in the at least one streaming unit, and whereby the at least one streaming unit is provided with a display frame that identifies the information provider, and
wherein the computer system is a user system in which the multimedia data on the streaming portal can be played back in a display frame that has been designed to play back all the data on the streaming portal and that identifies the information provider.

44. The computer system of claim 43, wherein the user system is fitted with a multimedia personal computer with an on screen user prompt.

45. The computer system of claim 43, wherein the user system is a home recorder.

46. A method of using a computer system for providing a streaming portal with at least one display frame for playback of multimedia information of a program offered by an information provider, comprising:
making the multimedia information available for the streaming portal as multimedia data;
making the multimedia data available for playback as a group of data streams;
dividing the multimedia data into a group of streaming units of the configuration data from the program;
marking at least one streaming unit with an identification of the type of multimedia data contained in the at least one streaming unit;
providing the streaming unit with a display frame for playback as a data stream that identifies the information provider,
wherein the computer system is a user system in which the multimedia data on the streaming portal can be played back in a display frame that has been designed to play back all the data on the streaming portal and that identifies the information provider.
